(19) United States
(12) Patent Application Publication
(10) Pub. No.: US 2024/0234730 A1
(43) Pub. Date: Jul. 11, 2024

(54) ELECTROCHEMICAL DEVICE AND ELECTRONIC DEVICE

(71) Applicant: Dongguan Amperex Technology Limited, Dongguan (CN)

(72) Inventor: Dou YING, Dongguan (CN)

(73) Assignee: Dongguan Amperex Technology Limited, Dongguan (CN)

(21) Appl. No.: 18/615,002

(22) Filed: Mar. 25, 2024

Related U.S. Application Data
(63) Continuation of application No. PCT/CN2021/121744, filed on Sep. 29, 2021.

(51) Int. Cl. H01M 4/60; H01M 4/131; H01M 4/50

(52) U.S. Cl. CPC H01M 4/602; H01M 4/131; H01M 4/50

(57) ABSTRACT

An electrochemical device includes an electrode plate. The electrode plate includes a current collector, a conductive layer, and an active material layer. The conductive layer is disposed between the current collector and the active material layer. The electrochemical device satisfies the following relation: 0.7<T/(2087.1×CW−76.8)<1.2, where T (nm) is a thickness of the conductive layer, and CW (mg/cm²) is a coating weight of the conductive layer per unit area of the current collector. The electrochemical device that satisfies the above condition exhibits a relatively high energy density.

### CROSS REFERENCE TO THE RELATED APPLICATIONS

This application is a continuation under 35 U.S.C. § 120 of international patent application PCT/CN2021/121744 filed on Sep. 29, 2021, the entire content of which is incorporated herein by reference.

### TECHNICAL FIELD

This application relates to the field of energy storage, and in particular, to an electrochemical device and an electronic device.

### BACKGROUND

Lithium-ion batteries are very widely used by virtue of advantages such as a high energy density, a long cycle life, and a low self-discharge rate. With continuous progress of technology, people are imposing higher requirements on the energy density of the lithium-ion batteries. How to improve the energy density of the lithium-ion batteries becomes a hot topic of research.

Currently, during preparation of a lithium-ion battery, an undercoat is applied between an active material layer and a current collector, and is configured to increase the adhesion between the active material layer and the current collector and reduce a film resistance of an electrode plate. However, the introduction of the undercoat increases the thickness of the electrode plate and a battery cell to some extent. The greater the thickness, the lower the compaction density and energy density of the battery, and the higher the manufacturing cost and the material cost.

### SUMMARY

In view of the problems in the prior art, this application provides an electrochemical device and an electronic device containing the electrochemical device.

According to a first aspect, this application provides an electrochemical device. The electrochemical device includes an electrode plate. The electrode plate includes a current collector, a conductive layer, and an active material layer. The conductive layer is disposed between the current collector and the active material layer. The electrochemical device satisfies the following relation: 0.7<T/(2087.1×CW−76.8)<1.2, where T (nm) is a thickness of the conductive layer, and CW (mg/cm²) is a coating weight of the conductive layer per unit area of the current collector. The electrochemical device that satisfies the above condition exhibits a relatively high energy density. When the value of T/(2087.1×CW-76.8) is unduly low, in order to obtain a low thickness of the conductive layer, a high-precision plate roller is required in the coating stage, thereby increasing the preparation cost of the electrochemical device and reducing the cost-effectiveness. When the value of T/(2087.1×CW−76.8) is unduly high, a conductive layer slurry of a high solid content is required in the coating process. The high solid content of the conductive layer slurry makes the particles of the conductive layer prone to agglomerate with each other, and it is more difficult to spread out the conductive layer, thereby causing an adverse effect onto the resistance and energy density of the electrochemical device.

According to some embodiments of this application, 0.8<T/(2087.1×CW−76.8)<1.2.

According to some embodiments of this application, 100<T≤2000. An unduly thick conductive layer results in a decline in the energy density of the electrochemical device. According to some embodiments of this application, 200<T≤1500.

According to some embodiments of this application, 0.1<CW≤1. A small coating weight of the conductive layer results in a low content of the conductive agent in the conductive layer and low adhesion of the conductive layer, thereby making the conductive layer unable to provide good electrical conductivity and sufficient adhesion. The poor conductivity increases the electronic impedance of the electrochemical device, and deteriorates the C-rate performance. If the adhesion is insufficient, the active material layer is prone to fall off, thereby causing the electrochemical device to incur a plunge of the cycle capacity at a later stage of cycling. According to some embodiments of this application, 0.3<CW≤0.8.

According to some embodiments of this application, a contact angle θ of the conductive layer with respect to N-methyl-pyrrolidone satisfies: 200≤θ≤50°. The contact angle θ is measured by a contact angle meter. When the contact angle is unduly large, the active material layer slurry is poorly infiltrative and more difficult to spread out on the conductive layer, thereby being unfavorable to subsequent leveling of the active material layer slurry. When the contact angle is unduly small, the active material layer slurry is of high fluidity, and flows easily during drying, thereby leading to an increase in the surface roughness of the active material layer. In addition, in view of the limitations of the conductive layer, it is very difficult to achieve a very small contact angle.

According to some embodiments of this application, the conductive layer includes a secondary particle formed from a primary particle of a conductive agent. D₅₀ and D₉₀ of the secondary particle satisfy: 0.1 μm≤D₅₀≤0.4 μm, and 0.2 μm≤D₉₀≤0.6 μm. The higher the values of D₅₀ and D₉₀ of the secondary particles, the higher the thickness of the conductive layer. An unduly thick conductive layer results in a decline in the compaction density and energy density of the electrochemical device.

According to some embodiments of this application, the conductive layer includes a first additive and a second additive. The first additive includes at least one of a polyether polyol or a cellulose ether. The second additive includes at least one of a polycarboxylate salt, a polycarboxylate ester, or a polycarboxylic acid. In this application, both the first additive and the second additive are bonded to the conductive agent, and there is also an intermolecular force between the first additive and the second additive. The two additives work together and combine with different conductive agents to form a meshed bonding structure. Under a shear force, the network bonding structure can effectively disperse the conductive agent to ultimately maintain a relatively small particle diameter of the secondary particles of the conductive agent in the conductive layer.

According to some embodiments of this application, the weight-average molecular weight of the first additive is 400000 to 800000. According to some embodiments of this application, the weight-average molecular weight of the second additive is 300000 to 600000. If the molecular weight of the additive is unduly low, the effect of dispersing the conductive agent will be low, and the particle diameter of the secondary particles will be unduly large, thereby increasing the thickness of the conductive layer. An unduly thick conductive layer results in a decline in the energy density of the electrochemical device and an increase in the internal resistance of the electrochemical device, thereby being unfavorable to the improvement of the kinetic performance of the electrochemical device. If the molecular weight of the additive is unduly high, the viscosity of the additive will be unduly high, and stirring the additive will be energy-consuming and ineffective.

According to some embodiments of this application, the polyether polyol includes at least one of a trihydroxy polyether, a phenol polyoxyethylene ether, a polyethylene glycol dimethyl ether, or a polyether-modified glycerol; the cellulose ether includes at least one of methyl cellulose, hydroxyethyl methyl cellulose, carboxymethyl cellulose, sodium carboxymethyl cellulose, ethyl cellulose, benzyl cellulose, hydroxyethyl cellulose, hydroxypropyl cellulose, cyanoethyl cellulose, benzyl cyanoethyl cellulose, carboxymethyl hydroxyethyl cellulose, or phenyl cellulose; the polycarboxylate salt includes at least one of sodium polyacrylate or sodium polymethacrylate; the polycarboxylic acid includes at least one of a polyacrylic acid or a polymethacrylic acid; and the polycarboxylate ester includes at least one of polyvinyl acetate, poly(2-hydroxyethyl methacrylate), or poly(isobutyl methacrylate).

According to some embodiments of this application, based on a total mass of the conductive layer, a mass percent of the first additive is 1% to 5%, and a mass percent of the second additive is 20% to 55%. When the content of the first additive and the second additive is unduly low, the dispersion effect of the conductive agent is low, the secondary particles of the conductive layer are relatively large, the thickness of the conductive layer is large, and the volumetric energy density of the electrochemical device is low. In addition, when the content of the additives is unduly low, the rigidity of the additives is high, thereby affecting the compaction density of the electrochemical device. When the content of the first additive and the second additive is unduly high, the content of the conductive agent will decrease accordingly, the conductivity of the conductive layer will become low, and the internal resistance of the electrochemical device will increase.

According to some embodiments of this application, a mass ratio between the first additive and the second additive is 1:4 to 1:50. Compared to the first additive, the second additive is of low rigidity and high adhesion. Therefore, a relatively high content of the second additive can further increase the energy density of the electrochemical device.

According to some embodiments of this application, the conductive agent satisfies at least one of the following conditions (m) to (o): (m) the conductive agent includes at least one of conductive carbon black, acetylene black, carbon fibers, carbon nanotubes, or Ketjen black; (n) a specific surface area of the conductive agent is 50 m²/g to 100 m²/g; or, (o) based on a total mass of the conductive layer, a mass percent of the conductive agent is 40% to 75%. The conductivity is impaired when the specific surface area of the conductive agent is unduly small, that is, when the particle diameter of the conductive agent is large. When the specific surface area of the conductive agent is unduly large, the intermolecular force of the conductive agent is large, thereby hindering dispersion of the conductive agent.

According to some embodiments of this application, a solid content of a conductive layer slurry that forms the conductive layer is 3% to 25%. An unduly high solid content leads to a large thickness of the conductive layer, thereby reducing the energy density. An unduly low solid content may result in omission of coating of the conductive layer, thereby affecting the resistance and adhesion, and in turn, impairing the performance of the electrochemical device.

According to some embodiments of this application, the electrode plate is a positive electrode plate. According to some embodiments of this application, the electrode plate is a negative electrode plate.

According to some embodiments of this application, the electrode plate satisfies at least one of the following conditions (p) to (s): (p) a film resistance of the electrode plate is 0.05Ω to 5Ω; (q) an adhesion force between the conductive layer and the active material layer is 10 N/m to 100 N/m; (r) a compaction density of the electrode plate is 2.0 g/cm³ to 2.5 g/cm³; or (s) a porosity of the electrode plate is 20% to 50%.

According to some embodiments of this application, the adhesion force between the conductive layer and the active material layer is 10 N/m to 100 N/m. When the adhesion force is less than 10 N/m, the adhesion between the conductive layer and the active material layer is insufficient, and debonding between the conductive layer and the active material layer tends to occur at a later stage of cycling, thereby deteriorating the performance. If the adhesion force is greater than 100 N/m, a possible reason is that the electrode plate becomes brittle due to an unduly high compaction density, leading to an exaggerated adhesion force.

According to some embodiments of this application, a compaction density of the electrode plate is 2.0 g/cm³ to 2.5 g/cm³. When the compaction density is unduly high, the force exerted by the active material on the current collector or the acting force between the particles of the active material is unduly large, thereby being prone to cause a break of the electrode plate (or the current collector being prone to be damaged, or the active material layer being prone to be brittle, depending on the system). In addition, when the compaction density is unduly high, voids inside the electrode plate are relatively small, thereby leading to a decrease in ionic conductivity and impairing the electrochemical performance. An unduly low compaction density results in a relatively low energy density of the electrochemical device.

According to a second aspect, this application provides an electronic device. The electronic device includes the electrochemical device according to the first aspect of this application.

### BRIEF DESCRIPTION OF DRAWINGS

FIG. 1 is a planar scanning electron microscopy (SEM) image of a positive electrode plate according to Embodiment 1-5 of this application; and

FIG. 2 is a cross-sectional scanning electron microscopy (SEM) image of a positive electrode plate according to Embodiment 1-5 of this application.

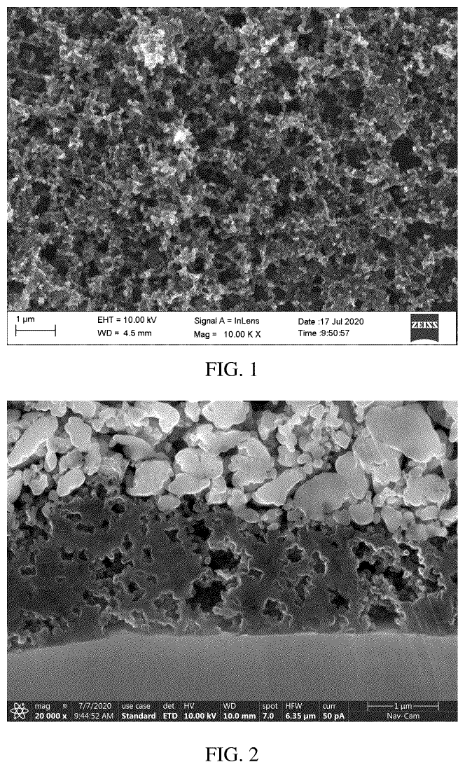

### DETAILED DESCRIPTION

Some embodiments of this application will be described in detail below. No embodiment of this application is to be construed as a limitation on this application.

A list of items referred to by using the terms such as “at least one of” may mean any combination of the listed items. For example, if items A and B are listed, the phrases “at least one of A and B” and “at least one of A or B” mean: A alone; B alone; or both A and B. In another example, if items A, B, and C are listed, the phrases “at least one of A, B, and C” and “at least one of A, B, or C” mean: A alone; B alone; C alone; A and B (excluding C); A and C (excluding B); B and C (excluding A); or all of A, B, and C. The item A may include a single element or a plurality of elements. The item B may include a single element or a plurality of elements. The item C may include a single element or a plurality of elements.

References to “embodiments”, “some embodiments”, “an embodiment”, “another example”, “example”, “specific example” or “some examples” throughout the specification mean that specified features, structures, materials, or characteristics described in such embodiment(s) or example(s) are included in at least one embodiment or example in this application. Therefore, descriptions throughout the specification, which make references by using expressions such as “in some embodiments”, “in an embodiment”, “in one embodiment”, “in another example”, “in an example”, “in a specific example”, or “example”, do not necessarily refer to the same embodiment(s) or example(s) in this application. In addition, specific features, structures, materials, or characteristics herein may be combined in one or more embodiments or examples in any appropriate manner.

According to a first aspect, this application provides an electrochemical device. The electrochemical device includes an electrode plate. The electrode plate includes a current collector, a conductive layer, and an active material layer. The conductive layer is disposed between the current collector and the active material layer. The electrochemical device satisfies the following relation: 0.7<T/(2087.1×CW−76.8)<1.2, where T (nm) is a thickness of the conductive layer, and CW (mg/cm²) is a coating weight of the conductive layer per unit area of the current collector. The electrochemical device that satisfies the above condition exhibits a relatively high energy density. When the value of T/(2087.1×CW−76.8) is unduly low, in order to obtain a low thickness of the conductive layer, a high-precision plate roller is required in the coating stage, thereby increasing the preparation cost of the electrochemical device and reducing the cost-effectiveness. When the value of T/(2087.1×CW−76.8) is unduly high, a conductive layer slurry of a high solid content is required in the coating process. The high solid content of the conductive layer slurry makes the particles of the conductive layer prone to agglomerate with each other, and it is more difficult to spread out the conductive layer, thereby causing an adverse effect onto the resistance and energy density of the electrochemical device.

In this application, a thickness of the conductive layer, denoted as T (nm), is a total thickness of the conductive layer in an electrode plate, that is, a sum of the thicknesses of the conductive layers on both sides of a current collector.

According to some embodiments of this application, T/(2087.1×CW−76.8) is 0.75, 0.85, 0.87, 0.93, 0.95, 0.97, 1.00, 1.01, 1.03, 1.05, 1.07, 1.09, 1.10, 1.13, 1.15, 1.17, 1.19, or a value falling within a range formed by any two thereof. According to some embodiments, 0.8<T/(2087.1×CW−76.8)<1.2. According to some embodiments, 0.85<T/(2087.1×CW−76.8)<1.15. When the value of T/(2087.1×CW−76.8) is greater than 0.7 and less than 0.8, it is difficult to implement the design in an existing manufacturing process, and the manufacturing cost will increase to some extent. When the value of T/(2087.1×CW−76.8) is greater than 0.8, it is easy to implement the design in the existing manufacturing process, without increasing the manufacturing cost.

According to some embodiments of this application, 100<T≤2000. In some embodiments, T is 200, 250, 300, 350, 400, 450, 500, 550, 600, 650, 700, 750, 800, 850, 900, 950, 1000, 1100, 1200, 1300, 1400, 1500, 1700, 1800, 1900, or a value falling within a range formed by any two thereof. In some embodiments, 200≤T≤1500. An unduly thick conductive layer results in a decline in the energy density of the electrochemical device.

According to some embodiments of this application, 0.1<CW≤1. In some embodiments, CW is 0.15, 0.20, 0.25, 0.30, 0.35, 0.40, 0.45, 0.50, 0.55, 0.60, 0.65, 0.70, 0.75, 0.80, 0.85, 0.90, 0.95, or a value falling within a range formed by any two thereof. In some embodiments, 0.3<CW≤0.8. A small coating weight of the conductive layer results in a low content of the conductive agent in the conductive layer and low adhesion of the conductive layer, thereby making the conductive layer unable to provide good electrical conductivity and sufficient adhesion. The poor conductivity increases the electronic impedance of the electrochemical device, and deteriorates the C-rate performance. If the adhesion is insufficient, the active material layer is prone to fall off, thereby causing the electrochemical device to incur a plunge of the cycle capacity at a later stage of cycling.

According to some embodiments of this application, a contact angle θ of the conductive layer with respect to N-methyl-pyrrolidone satisfies: 200≤θ≤50°. The contact angle θ is measured by a contact angle meter. When the contact angle is unduly large, the active material layer slurry is poorly infiltrative and more difficult to spread out on the conductive layer, thereby being unfavorable to subsequent leveling of the active material layer slurry. When the contact angle is unduly small, the active material layer slurry is of high fluidity, and flows easily during drying, thereby leading to an increase in the surface roughness of the active material layer. In addition, in view of the limitations of the conductive layer, it is very difficult to achieve a very small contact angle.

According to some embodiments of this application, the conductive layer includes a secondary particle formed from a primary particle of a conductive agent. D₅₀ and D₉₀ of the secondary particle satisfy: 0.1 μm≤D₅₀≤0.4 μm, and 0.2 μm≤D₉₀≤0.6 μm. The higher the values of D₅₀ and D₉₀ of the secondary particles, the higher the thickness of the conductive layer. An unduly thick conductive layer results in a decline in the compaction density and energy density of the electrochemical device.

According to some embodiments of this application, D₅₀ of the secondary particles is 0.12 μm, 0.14 μm, 0.16 μm, 0.18 μm, 0.20 μm, 0.22 μm, 0.24 μm, 0.26 μm, 0.28 μm, 0.30 μm, 0.31 μm, 0.33 μm, 0.35 μm, 0.37 μm, 0.39 μm, or a value falling within a range formed by any two thereof. In some embodiments, D₅₀ of the secondary particles is 0.15 μm to 0.30 μm.

In some embodiments, D₉₀ of the secondary particles is 0.22 μm, 0.25 μm, 0.27 μm, 0.30 μm, 0.33 μm, 0.35 μm, 0.38 μm, 0.40 μm, 0.42 μm, 0.45 μm, 0.47 μm, 0.50 μm, 0.53 μm, 0.55 μm, 0.57 μm, or a value falling within a range formed by any two thereof. In some embodiments, D₉₀ of the secondary particles is 0.25 μm to 0.40 μm.

In this application, the term “secondary particle” means a particle formed by agglomerating primary particles of the conductive agent together. The term “D₅₀” represents a diameter of particles corresponding to a cumulative distribution percentage 50% in a particle size distribution curve. The term “D₉₀” represents a diameter of particles corresponding to a cumulative distribution percentage 90% in a particle size distribution curve. The particle diameter is measured by a laser particle size analyzer.

According to some embodiments of this application, the conductive layer includes a first additive and a second additive. In some embodiments, the first additive includes at least one of a polyether polyol or a cellulose ether. In some embodiments, the second additive includes at least one of a polycarboxylate salt, a polycarboxylate ester, or a polycarboxylic acid. In this application, both the first additive and the second additive are bonded to the conductive agent, and there is also an intermolecular force between the first additive and the second additive. The two additives work together and combine with different conductive agents to form a meshed bonding structure. Under a shear force, the network bonding structure can effectively disperse the conductive agent to ultimately maintain a relatively small particle diameter of the secondary particles of the conductive agent in the conductive layer, thereby reducing the thickness of the conductive layer, and increasing the compaction density and energy density of the electrochemical device containing the conductive layer.

According to some embodiments of this application, the morphology of the conductive layer is an irregular corrugated surface formed of conductive agents and additives, and is characterized by multi-site meshed conductive paths and a dual-adhesive layer, where the dual-adhesive layer provides adhesion between the active material layer and the conductive layer, and adhesion between the conductive layer and the current collector layer. The multi-site meshed conductive paths can enrich the conductive network of the electrode plate, reduce the internal resistances of the electrode plate and the battery cell, and improve the kinetics of the battery cell. In addition, the dual-adhesive layer leads to a closer contact between the active layer and a substrate, and avoids a “plunge” of capacity during cycling caused by detachment of the active material.

According to some embodiments of this application, the weight-average molecular weight of the first additive is 400000 to 800000. The weight-average molecular weight of the first additive is 410000, 430000, 450000, 470000, 490000, 500000, 520000, 540000, 550000, 570000, 590000, 600000, 620000, 650000, 670000, 700000, 720000, 740000, 760000, 780000, or a value falling within a range formed by any two thereof.

According to some embodiments of this application, the weight-average molecular weight of the second additive is 300000 to 600000. In some embodiments, the weight-average molecular weight of the second additive is 310000, 330000, 350000, 370000, 390000, 400000, 420000, 440000, 450000, 470000, 490000, 500000, 520000, 550000, 570000, 590000, or a value falling within a range formed by any two thereof. For example, in the conductive layer slurry, molecular chain segments of the additive may be bonded to different conductive agents. The molecular chain segments bonded to different conductive agent agglomerates divide the conductive agent agglomerates after being pulled by a shear force, thereby effectively dispersing the conductive agent. If the molecular weight of the additive is unduly low, that is, if the molecular chain segments are short, then few molecular chain segments are bonded to the conductive agents, thereby leading to a low effect of dispersing the conductive agent. Consequently, the particle diameter of the secondary particles is unduly large, thereby increasing the thickness of the conductive layer. An unduly thick conductive layer results in a decline in the energy density of the electrochemical device and an increase in the internal resistance of the electrochemical device, thereby being unfavorable to the improvement of the kinetic performance of the electrochemical device. If the molecular weight of the additive is unduly high, the viscosity of the additive will be unduly high, and stirring the additive will be energy-consuming and ineffective.

According to some embodiments of this application, the first additive includes a polyether polyol. The polyether polyol includes at least one of a trihydroxy polyether, a phenol polyoxyethylene ether, a polyethylene glycol dimethyl ether, or a polyether-modified glycerol.

According to some embodiments of this application, the first additive includes a cellulose ether. The cellulose ether includes at least one of methyl cellulose, hydroxyethyl methyl cellulose, carboxymethyl cellulose, sodium carboxymethyl cellulose, ethyl cellulose, benzyl cellulose, hydroxyethyl cellulose, hydroxypropylmethylcellulose, cyanoethyl cellulose, benzyl cyanoethyl cellulose, carboxymethyl hydroxyethyl cellulose, or phenyl cellulose.

In some embodiments of this application, the first additive includes at least one of a trihydroxy polyether, a phenol polyoxyethylene ether, a polyethylene glycol dimethyl ether, a polyether-modified glycerol, sodium carboxymethyl cellulose, hydroxypropyl cellulose, or ethyl cellulose. The hydroxyl group in the first additive can increase wettability, and on the other hand, can bond with the carboxyl group in the second additive, thereby facilitating formation of a cross-linked network between the additive and the conductive agent.

According to some embodiments of this application, the second additive includes a polycarboxylate salt. The polycarboxylate salt includes the following structural unit A:

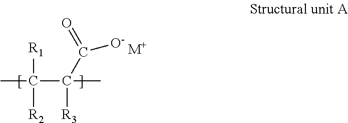

In the structural formula above, R₁ to R₃ are identical or different, each independently selected from hydrogen or a C₁ to C₆ alkyl; and M is selected from alkali metals. In some embodiments, R₁ to R₃ are identical or different, each independently selected from hydrogen, methyl, ethyl, n-propyl, isopropyl, n-butyl, isobutyl, sec-butyl, or tert-butyl. M is sodium or potassium. In some embodiments, the polycarboxylate salt includes at least one of sodium polyacrylate or sodium polymethacrylate.

According to some embodiments of this application, the second additive includes a polycarboxylic acid. The polycarboxylic acid includes the following structural unit B:

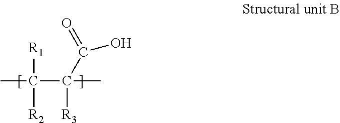

In the structural formula above, R₁ to R₃ are identical or different, each independently selected from hydrogen or a C₁ to C₆ alkyl. In some embodiments, R₁ to R₃ are identical or different, each independently selected from hydrogen, methyl, ethyl, n-propyl, isopropyl, n-butyl, isobutyl, sec-butyl, or tert-butyl. In some embodiments, the polycarboxylic acid includes at least one of polyacrylic acid or polymethacrylic acid.

According to some embodiments of this application, the second additive includes a polycarboxylate ester. The polycarboxylate ester includes the following structural unit C:

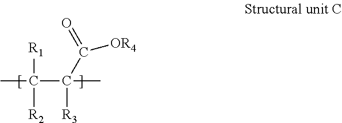

In the structural formula above, R₁ to R₃ are identical or different, each independently selected from hydrogen or a C₁ to C₆ alkyl; and R₄ is selected from a C₁ to C₆ alkyl or a hydroxy-substituted C₁ to C₆ alkyl. In some embodiments, R₁ to R₃ are identical or different, each independently selected from hydrogen, methyl, ethyl, n-propyl, isopropyl, n-butyl, isobutyl, sec-butyl, or tert-butyl. R₄ is selected from methyl, ethyl, n-propyl, isopropyl, n-butyl, isobutyl, sec-butyl, tert-butyl, hydroxy-substituted methyl, hydroxy-substituted ethyl, or hydroxy-substituted propyl. In some embodiments, the polycarboxylate ester includes at least one of poly(2-hydroxyethyl methacrylate) or poly(isobutyl methacrylate).

According to some embodiments of this application, the second additive includes a polycarboxylate ester. The polycarboxylate ester includes the following structural unit D:

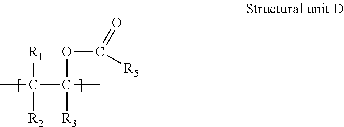

In the structural formula above, R₁ to R₃ are identical or different, each independently selected from hydrogen or a C₁ to C₆ alkyl; and R₅ is selected from a C₁ to C₆ alkyl or a hydroxy-substituted C₁ to C₆ alkyl. In some embodiments, R₁ to R₃ are identical or different, each independently selected from hydrogen, methyl, ethyl, n-propyl, isopropyl, n-butyl, isobutyl, sec-butyl, or tert-butyl. R₅ is selected from methyl, ethyl, n-propyl, isopropyl, n-butyl, isobutyl, sec-butyl, tert-butyl, hydroxy-substituted methyl, hydroxy-substituted ethyl, or hydroxy-substituted propyl. In some embodiments, the polycarboxylate ester includes polyvinyl acetate.

According to some embodiments of this application, the second additive includes at least one of sodium poly acrylate, sodium polymethacrylate, poly acrylic acid, polymethacrylic acid, polyvinyl acetate, poly(2-hydroxyethyl methacrylate), or poly(isobutyl methacrylate). The carboxyl group in the second additive can bond with the residual oxygen-containing functional group on the conductive agent, and on the other hand, can bond with the hydroxyl group in the first additive, thereby facilitating formation of a cross-linked network between the additive and the conductive agent.

According to some embodiments of this application, based on a total mass of the conductive layer, a mass percent of the first additive is 1% to 5%. In some embodiments, the mass percent of the first additive is 1.5%, 2.0%, 2.5%, 3.0%, 3.5%, 4.5%, 5.0%, or a value falling within a range formed by any two thereof.

According to some embodiments of this application, the mass percent of the second additive is 20% to 55%. In some embodiments, the mass percent of the second additive is 25%, 30%, 35%, 40%, 45%, 50%, or a value falling within a range formed by any two thereof. When the content of the first additive and the second additive is unduly low, the dispersion effect of the conductive agent is low, the secondary particles of the conductive layer are relatively large, the thickness of the conductive layer is large, and the volumetric energy density of the electrochemical device is low. In addition, when the content of the additives is unduly low, the rigidity of the additives is high, thereby affecting the compaction density of the electrochemical device. When the content of the first additive and the second additive is unduly high, the content of the conductive agent will decrease accordingly, the conductivity of the conductive layer will become low, and the internal resistance of the electrochemical device will increase.

According to some embodiments of this application, a mass ratio between the first additive and the second additive is 1:4 to 1:50. In some embodiments, the mass ratio between the first additive and the second additive is 1:5, 1:10, 1:15, 1:20, 1:25, 1:30, 1:35, 1:40, 1:45, or a value falling within a range formed by any two thereof. Compared to the first additive, the second additive is of low rigidity and high adhesion. Therefore, a relatively high content of the second additive can further increase the energy density of the electrochemical device.

According to some embodiments of this application, the conductive agent includes at least one of conductive carbon black, acetylene black, carbon fibers, carbon nanotubes, or Ketjen black.

According to some embodiments of this application, the specific surface area of the conductive agent is 50 m²/g to 100 m²/g. In some embodiments, the specific surface area of the conductive agent is 55 m²/g, 60 m²/g, 65 m²/g, 70 m²/g, 75 m²/g, 80 m²/g, 85 m²/g, 90 m²/g, 95 m²/g, or a value falling within a range formed by any two thereof. The conductivity is impaired when the specific surface area of the conductive agent is unduly small, that is, when the particle diameter of the conductive agent is large. When the specific surface area of the conductive agent is unduly large, the intermolecular force of the conductive agent is large, thereby hindering dispersion of the conductive agent.

According to some embodiments of this application, based on the total mass of the conductive layer, the mass percent of the conductive agent is 40% to 75%. In some embodiments, the mass percent of the conductive agent is 42%, 45%, 47%, 50%, 53%, 55%, 57%, 59%, 62%, 65%, 67%, 69%, 71%, 73%, or a value falling within a range formed by any two thereof. When the content of the conductive agent is unduly low, the conductivity of the conductive layer will become low, and the electronic impedance of the electrochemical device will increase. When the content of the conductive agent is unduly high, the adhesion force of the conductive layer is insufficient, and the safety performance of the electrochemical device is low.

According to some embodiments of this application, a solid content of a conductive layer slurry that forms the conductive layer is 3% to 25%. In some embodiments, the solid content of the conductive layer slurry is 5%, 7%, 9%, 11%, 13%, 15%, 17%, 19%, 20%, 21%, 23%, or a value falling within a range formed by any two thereof. An unduly high solid content leads to a large thickness of the conductive layer, thereby reducing the energy density. An unduly low solid content may result in omission of coating of the conductive layer, thereby affecting the resistance and adhesion, and in turn, impairing the performance of the electrochemical device.

In a coating process of the conductive layer, the thickness of a gravure corresponds to the coating amount. The coating amount is related to the ink amount and the solid content. The higher the ink amount, the higher the solid content of the gravure slurry, and the larger the coating amount. In a case that the gravure rollers are consistent, the thicknesses of the wet films are theoretically identical. Therefore, the gravure coating weight can be regulated by adjusting the solid content of the slurry.

According to some embodiments of this application, the film resistance of the electrode plate is 0.05Ω to 5Ω. For example, the film resistance of the electrode plate is 0.5Ω, 1.0Ω, 1.5Ω, 2.0Ω, 2.5Ω, 3.0Ω, 3.5Ω, 4.0Ω, 4.5Ω, or a value falling within a range formed by any two thereof. In some embodiments, the film resistance of the electrode plate is 0.5Ω to 2Ω.

According to some embodiments of this application, the adhesion force between the conductive layer and the active material layer of the electrode plate is 10 N/m to 100 N/m. According to some embodiments of this application, the adhesion force between the conductive layer and the active material layer of the electrode plate is 15 N/m, 20 N/m, 25 N/m, 30 N/m, 35 N/m, 40 N/m, 45 N/m, 50 N/m, 55 N/m, 60 N/m, 65 N/m, 70 N/m, 80 N/m, or a value falling within a range formed by any two thereof. In some embodiments, the adhesion force between the conductive layer and the active material layer is 20 N/m to 60 N/m. When the adhesion force is unduly low, the adhesion between the conductive layer and the active material layer is insufficient, and debonding between the conductive layer and the active material layer tends to occur at a later stage of cycling, thereby deteriorating the performance. When the adhesion force is unduly high, a possible reason is that the electrode plate becomes brittle due to an unduly high compaction density, leading to an exaggerated adhesion force.

According to some embodiments of this application, a compaction density of the electrode plate is 2.0 g/cm³ to 2.5 g/cm³. In some embodiments, the compaction density of the electrode plate is 2.1 g/cm³, 2.15 g/cm³, 2.2 g/cm³, 2.25 g/cm³, 2.3 g/cm³, 2.35 g/cm³, 2.4 g/cm³, 2.45 g/cm³, or a value falling within a range formed by any two thereof. When the compaction density is unduly high, the force exerted by the active material on the current collector or the acting force between the particles of the active material is unduly large, thereby being prone to cause a break of the electrode plate (or the current collector being prone to be damaged, or the active layer being prone to be brittle, depending on the system). In addition, when the compaction density is unduly high, voids inside the electrode plate are relatively small, thereby leading to a decrease in ionic conductivity and impairing the electrochemical performance. An unduly low compaction density results in a relatively low energy density of the electrochemical device.

According to some embodiments of this application, the porosity of the electrode plate is 20% to 50%. In some embodiments, the porosity of the electrode plate is 25%, 30%, 35%, 40%, 45%, or a value falling within a range formed by any two thereof. Small voids in the electrode plate result in a decrease in ionic conductivity and impair the electrical performance.

According to some embodiments of this application, the electrode plate is a positive electrode plate and/or a negative electrode plate. In some embodiments, the electrode plate is a positive electrode plate. In some embodiments, the electrode plate is a negative electrode plate.

According to some embodiments of this application, the active material layer includes a positive active material or a negative active material. In some embodiments, the positive active material may include at least one of lithium nickel cobalt manganese oxide (NCM811, NCM622, NCM523, NCM111), lithium nickel cobalt aluminum oxide, lithium iron phosphate, a lithium-rich manganese-based material, lithium cobalt oxide, lithium manganese oxide, lithium manganese iron phosphate, or lithium titanium oxide. In some embodiments, the negative active material may include a material that enables reversible intercalation and deintercalation of lithium ions, lithium metal, lithium metal alloy, a material capable of being doped with or stripped of lithium, or transition metal oxide, for example, Si, SiOₓ (0<x<2). The material that enables reversible intercalation and deintercalation of lithium ions may be a carbon material. The carbon material may be any carbon-based negative active material typically used in a lithium-ion rechargeable electrochemical device. Examples of the carbon material include crystalline carbon, non-crystalline carbon, and a combination thereof. The crystalline carbon may be amorphous or plate-shaped, mini-flake-shaped, spherical or fibrous natural graphite or artificial graphite. The non-crystalline carbon may be soft carbon, hard carbon, mesophase pitch carbonization products, fired coke, or the like. Both low crystalline carbon and high crystalline carbon may be used as carbon materials. A low crystalline carbon material typically includes soft carbon and hard carbon. High crystalline carbon materials typically include natural graphite, crystalline graphite, pyrolytic carbon, mesophase pitch-based carbon fibers, mesophase carbon microbeads, mesophase pitch, or high-temperature calcined carbon (for example, petroleum, or coke derived from coal tar pitch).

According to some embodiments of this application, the active material layer further includes a binder. In some embodiments, the binder may include various binder polymers, such as at least one of polyvinylidene fluoride, polytetrafluoroethylene, polyolefins, sodium carboxymethylcellulose, lithium carboxymethylcellulose, modified polyvinylidene fluoride, modified SBR rubber, or polyurethane. In some embodiments, the polyolefin binders include at least one of polyethylene, polypropylene, polyvinyl ester, polyvinyl alcohol, or polyacrylic acid.

According to some embodiments of this application, the active material layer further includes a conductive material to improve electrode conductivity. Any electrically conductive material may be used as the conductive material as long as the material does not cause chemical changes. Examples of the conductive material include: a carbon-based material (for example, natural graphite, artificial graphite, carbon black, acetylene black, Ketjen black, and carbon fiber), a metal-based material (for example, metal powder or metal fiber containing copper, nickel, aluminum, silver, and the like), a conductive polymer (for example, a polyphenylene derivative), and any mixture thereof.

According to some embodiments of this application, the current collector includes a positive current collector or a negative current collector. In some embodiments, the positive current collector may be metal foil or a composite current collector. For example, the positive current collector may be an aluminum foil. The composite current collector may be formed by disposing a metal material (copper, copper alloy, nickel, nickel alloy, titanium, titanium alloy, silver, silver alloy, and the like) on a polymer substrate. In some embodiments, the negative current collector may be copper foil, a nickel foil, stainless steel foil, titanium foil, foamed nickel, foamed copper, a conductive-metal-clad polymer substrate, or any combination thereof.

The electrochemical device according to this application further includes an electrolytic solution. The electrolytic solution includes a lithium salt and a nonaqueous solvent.

In some embodiments of this application, the lithium salt is at least one selected from LiPF₆, LiBF₄, LiAsF₆, LiClO₄, LiB(C₆H₅)₄, LiCH₃SO₃, LiCF₃SO₃, LiN(SO₂CF₃)₂, LiC(SO₂CF₃)₃, LiSiF₆, LiBOB, and lithium difluoroborate. For example, the lithium salt is LiPF₆ because it provides a high ionic conductivity and improves cycle properties.

The nonaqueous solvent may be a carbonate compound, a carboxylate compound, an ether compound, another organic solvent, or any combination thereof.

The carbonate compound may be a chain carbonate compound, a cyclic carbonate compound, a fluorocarbonate compound, or any combination thereof.

Examples of the chain carbonate compound are dimethyl carbonate (DMC), diethyl carbonate (DEC), dipropyl carbonate (DPC), methyl propyl carbonate (MPC), ethylene propyl carbonate (EPC), ethyl methyl carbonate (EMC), or any combination thereof. Examples of the cyclic carbonate compound are ethylene carbonate (EC), propylene carbonate (PC), butylene carbonate (BC), vinyl ethylene carbonate (VEC), or any combination thereof. Examples of the fluorocarbonate compound are fluoroethylene carbonate (FEC), 1,2-difluoroethylene carbonate, 1,1-difluoroethylene carbonate, 1,1,2-trifluoroethylene carbonate, 1,1,2,2-tetrafluoroethylene carbonate, 1-fluoro-2-methyl ethylene, 1-fluoro-1-methyl ethylene carbonate, 1,2-difluoro-1-methyl ethylene carbonate, 1,1,2-trifluoro-2-methyl ethylene carbonate, trifluoromethyl ethylene carbonate, or any combination thereof.

Examples of the carboxylate compound are methyl formate, methyl acetate, ethyl acetate, n-propyl acetate, tert-butyl acetate, methyl propionate, ethyl propionate, propyl propionate, γ-butyrolactone, decanolactone, valerolactone, mevalonolactone, caprolactone, or any combination thereof.

Examples of the ether compound are dibutyl ether, tetraglyme, diglyme, 1,2-dimethoxyethane, 1,2-diethoxyethane, ethoxy-methoxyethane, 2-methyltetrahydrofuran, tetrahydrofuran, or any combination thereof.

Examples of the other organic solvent are dimethyl sulfoxide, 1,2-dioxolane, sulfolane, methyl sulfolane, 1,3-dimethyl-2-imidazolidinone, N-methyl-2-pyrrolidone, formamide, dimethylformamide, acetonitrile, trimethyl phosphate, triethyl phosphate, trioctyl phosphate, phosphate ester and any combination thereof.

The electrochemical device of this application further includes a separator. The material and the shape of the separator are not particularly limited herein, and may be based on any technology disclosed in the prior art. In some embodiments, the separator includes a polymer or an inorganic compound or the like formed from a material that is stable to the electrolytic solution disclosed in this application.

For example, the separator may include a substrate layer and a surface treatment layer. The substrate layer is a non-woven fabric, film or composite film, which, in each case, is of a porous structure. The material of the substrate layer is at least one selected from polyethylene, polypropylene, polyethylene terephthalate, and polyimide. Specifically, the material of the substrate layer may be a polypropylene porous film, a polyethylene porous film, a polypropylene non-woven fabric, a polyethylene non-woven fabric, or a polypropylene-polyethylene-polypropylene porous composite film.

The surface treatment layer is disposed on at least one surface of the substrate layer. The surface treatment layer may be a polymer layer or an inorganic compound layer, or a layer formed by mixing a polymer and an inorganic compound.

The inorganic compound layer includes inorganic particles and a binder. The inorganic particles are at least one selected from: aluminum oxide, silicon oxide, magnesium oxide, titanium oxide, hafnium dioxide, tin oxide, ceria, nickel oxide, zinc oxide, calcium oxide, zirconium oxide, yttrium oxide, silicon carbide, boehmite, aluminum hydroxide, magnesium hydroxide, calcium hydroxide, or barium sulfate. The binder is at least one selected from polyvinylidene fluoride, vinylidene fluoride-hexafluoropropylene copolymer, polyamide, polyacrylonitrile, polyacrylate, polyacrylic acid, polyacrylate, polyvinylpyrrolidone, polyvinyl alkoxide, poly methyl methacrylate, polytetrafluoroethylene, or polyhexafluoropropylene.

The polymer layer includes a polymer. The material of the polymer is at least one selected from polyamide, polyacrylonitrile, acrylate polymer, polyacrylic acid, polyacrylic acid sodium salt, polyvinylpyrrolidone, polyvinyl alkoxide, polyvinylidene difluoride, or poly(vinylidene fluoride-co-hexafluoropropylene).

According to a second aspect, this application provides an electronic device. The electronic device includes the electrochemical device according to the first aspect of this application.

The electronic device or apparatus according to this application is not particularly limited. In some embodiments, the electronic devices of this application include, but are not limited to, a notebook computer, pen-inputting computer, mobile computer, e-book player, portable phone, portable fax machine, portable photocopier, portable printer, stereo headset, video recorder, liquid crystal display television set, handheld cleaner, portable CD player, mini CD-ROM, transceiver, electronic notepad, calculator, memory card, portable voice recorder, radio, backup power supply, motor, automobile, motorcycle, power-assisted bicycle, bicycle, lighting appliance, toy, game console, watch, electric tool, flashlight, camera, large household battery, lithium-ion capacitor, and the like.

This application is further described below with reference to some embodiments. Understandably, such embodiments are merely intended to illustrate this application but not to limit the scope of this application.

### Test Methods

1. Calculating the coating weight CW of the conductive layer: Disassembling a battery cell to obtain an electrode plate; washing and air-drying the electrode plate, and then washing the active layer away by using an NMP solvent, or removing the active layer by using adhesive tape; cutting the electrode plate into small square specimens by using a special die, where the area of each specimen is 86×85.2 mm²; weighing the specimen, and recording the weight as M_{current collector+conductive layer}, measured in units of mg. Subsequently, wiping away the conductive layer, weighing the current collector, and recording the weight as m_{current collector}, measured in units of mg. Calculating the coating weight as: CW=(M_{current collector+conductive layer}−m_{current collector})×100/(86×85.2).

2. Testing the thickness of the conductive layer: Disassembling a battery cell to obtain an electrode plate, washing and air-drying the electrode plate, and then washing the active layer away by using an NMP solvent, or removing the active layer by using adhesive tape; subsequently, measuring the total thickness of the current collector and the undercoating conductive layer in a single-point test method by using a ten-thousandth micrometer, and averaging out the values obtained at 15 points. Calculating the thickness of the conductive layer by subtracting the thickness of the current collector from the total thickness of the current collector and the undercoating conductive layer. Calculating the thickness of the conductive layer as: T=(T₁+T₂+T₃+ . . . +T₁₅)/15−T_{(current collector)}.

3. Testing the particle size of the conductive layer: Disassembling a battery cell to obtain an electrode plate, washing and air-drying the electrode plate, and then washing the active layer away by using an NMP solvent, or removing the active layer by using adhesive tape; and subsequently, dissolving the conductive layer in deionized water to obtain a test-piece slurry. Testing the test-piece slurry by using a Malvern laser particle size analyzer. Specifically, selecting a Hydro SM Starter Sample (SOP) mode, using deionized water as a solvent, setting the rotation speed to 2800±400 rpm, and setting the refractive index to 1.52. Measuring the pure solution (deionized water). Subtracting the background, and then taking the test-piece slurry with a burette, dripping the slurry slowly until a target amount (until the slurry turns green), and then tapping “Test”.

4. Measuring the contact angle: Measuring the contact angle by using a contact angle meter. First, removing, by using adhesive tape, the active layer off a positive electrode plate obtained by disassembling a battery cell, and then dripping N-methyl-pyrrolidone. Performing automatic measurement by using a five-point method, so as to obtain a contact angle.

5. Measuring the film resistance: Disassembling a battery cell to obtain an electrode plate. Washing away the electrolyte solution by using a DMC solution, and then measuring the film resistance by using a film resistance meter that has been wiped clean. Specifically, spreading the electrode plate flat, and measuring the resistance in a coated region at a middle position that is 25 mm away from the edge and the uncoated region. Measuring the resistance for 15 times, and averaging out the measured values. The test conditions are: a single-point mode, a pressure of 0.4 T, and a test time of 5 s at each point.

6. Measuring the adhesion force: Disassembling a battery cell to obtain an electrode plate, washing away the electrolyte solution by using a DMC solution, and then preparing specimens. First, cutting the electrode plate into specimens, each being 30 mm wide and 100 mm to 160 mm long. Affixing special-purpose double-sided tape onto a steel sheet, where the adhesive tape is 20 mm wide and 90 mm to 150 mm long. Affixing the cut-out specimen onto the double-sided tape, and placing the test side downward. Subsequently, inserting a paper tape beneath the electrode plate and fixing the paper tape by using a crepe adhesive, where the width of the paper tape is equal to the width of the specimen and the length of the paper tape is 80 to 200 mm greater than the length of the specimen. Testing the prepared specimen by using a GoTech tensile machine. Fixing the steel sheet, letting the tensile machine clamp the paper tape, puling the paper tape at a speed of 50 mm/min, and recording the values of force and displacement and obtaining the value of the adhesion force. Testing the specimens in groups, each containing 5 specimens. Averaging out the measured values.

7. Measuring the compaction density of the positive electrode plate: Disassembling a battery cell to obtain an electrode plate, washing away the electrolyte solution by using a DMC solution, and then preparing specimens. Cutting the electrode plate into 10 to 15 small discs with an area of 1540.25 mm² each by using a tablet press, weighing the small discs, recording the weight of each small disc as M (averaging out the measured values of 10 to 15 small discs) in units of mg, and recording the thickness of the small disc as H (measuring the thickness at 15 points by using a ten-thousandth micrometer, and averaging out the measured values) in units of mm. Subsequently, wiping off the conductive layer, and weighing the current collector, denoted as m (averaging out the measured weight values of 10 to 15 small discs) in units of mg, and recording the thickness of the current collector as h in units of mm. Calculating the compaction density as: PD=(M−m)/((H−h)×1540.25), measured in g/cm³.

8. Testing the porosity of the positive electrode plate: Disassembling a battery cell to obtain an electrode plate, washing away the electrolyte solution by using a DMC solution, and then preparing specimens. Cutting the electrode plate into small discs of 10 mm or 14 mm, ensuring that the surface of the small discs is flat and even without notches or active material debonding. Measuring the thickness of the small disc, denoted as H. Measuring the specific surface area of the small discs, denoted as S. Testing the porosity by using a gas replacement method. To be specific, putting a specimen in a true density tester, closing the test system, passing nitrogen into the system based on the specified procedure, measuring the gas pressure, calculating the volume based on the Boyle's law (PV=nRT), and then calculating the porosity.

The porosity of an electrode plate is a percentage of a pore volume in the electrode plate in the total volume of the electrode plate, calculated as P=(V−V₀)/V×100%, where V₀ is the true volume, and V is the apparent volume.

9. Testing the internal resistance (IMP) of a lithium-ion battery cell: Taking a battery cell as a test-piece, connecting the two tabs of the battery cell separately to the instrument, detecting the current I flowing through the battery cell and the applied voltage V, and calculating the internal resistance of the battery cell as R=V/I.

10. Testing the volumetric energy density (ED) of a lithium-ion battery: Taking a battery cell as a test-piece, charging the battery at a current of 1.5 C at a normal temperature until the voltage reaches 4.48 V, and then charging the battery at a constant voltage of 4.48 V until the current reaches 0.05 C. Leaving the battery to stand for 5 minutes, and then discharging the battery at a constant current of 0.025 C until the voltage reaches 3.0 V. Leaving the battery to stand for 5 minutes, and recording the capacity at this time as D in units of mAh. Subsequently, charging the battery cell at a current of 1.0 C until the voltage reaches 4.0 V, and measuring the length, width, and thickness of the battery cell at this time. Calculating the volume V of the battery cell in units of mm³, and calculating the volumetric energy density as: ED=(D×3.89×1000)/V, in units of Wh/L.

11. SEM test

Recording characterization parameters of a scanning electron microscope by using a Philips XL-30 field emission scanning electron microscope, and performing an SEM test under conditions of 10 kV and 10 mA.

### Embodiments and Comparative Embodiments

1. Preparing a positive electrode plate: Adding the conductive agent, the first additive, the second additive, and water as a solvent into a double planetary mixer. Stirring and dispersing the mixture with a solid content of 15%, so as to obtain a pre-dispersed conductive layer slurry. Diluting the pre-dispersed conductive layer slurry with water until a specified solid content, and then applying the slurry onto a current collector (aluminum foil) through a gravure machine, so as to obtain a current collector coated with a conductive layer. Subsequently, applying an active material slurry onto the current collector already coated with the conductive layer (the active material slurry is obtained by mixing well lithium cobalt oxide, acetylene black, and polyvinylidene fluoride at a mass ratio of 96:2:2 in an appropriate amount of N-methyl-pyrrolidone solvent), so as to form an active material layer. Performing drying and cold-pressing to obtain a positive electrode plate. In the mixture, the conductive agent is conductive carbon, the first additive is sodium carboxymethyl cellulose, and the second additive is sodium polyacrylate. The solid content of the specific conductive layer slurry as well as the constituents of the conductive agent, the first additive, and the second additive in each embodiment and comparative embodiment are set out in the following table.

2. Preparing a negative electrode plate: Mixing well graphite, polymethacrylic acid, and styrene-butadiene rubber at a mass ratio of 98:1:1 in an appropriate amount of deionized water solvent to form a homogeneous negative electrode slurry. Coating the current collector copper foil with the prepared negative electrode slurry, and performing drying and cold-pressing to obtain a negative electrode plate.

3. Preparing a lithium-ion battery: Stacking the positive electrode plate, the separator, and the negative electrode plate sequentially in such a way that the separator is located between the positive electrode and the negative electrode to serve a function of separation. Winding the stacked structure to obtain a bare cell. Putting the bare cell into an outer package, performing vacuum-drying, and then injecting an electrolyte solution, and sealing the package. Performing steps such as chemical formation, degassing, and edge trimming to obtain a lithium-ion battery. Using a 7 μm-thick polyethylene (PE) film as a separator. The electrolyte solution includes a solvent and LiPF₆. The solvent is a mixture of propylene carbonate (PC), ethylene carbonate (EC), and diethyl carbonate (DEC) mixed at a mass ratio of 1:1:1, and the concentration of LiPF₆ is approximately 1.15 mol/L.

Table 1 shows how the relationship between the thickness T (nm) of the conductive layer and the coating weight (mg/cm²) of the conductive layer per unit area of the current collector affects the positive electrode plate and the performance of the lithium-ion battery containing the positive electrode plate.

In each embodiment and comparative embodiment, the solid content of the conductive layer slurry is 15%; the weight-average molecular weight of the first additive is 650000, and the molecular weight distribution index of the first additive is 1.32; the weight-average molecular weight of the second additive is 450000, and the molecular weight distribution index of the second additive is 1.57; the specific surface area of the conductive agent is 65 m²/g; and D₅₀ of the secondary particles of the conductive layer is 0.195 μm, and D₉₀ thereof is 0.261 μm.

Based on the mass of the conductive layer, the mass percent of the first additive is 2.5%, the mass percent of the second additive is 47.5%, and the mass percent of the conductive agent is 50%.

TABLE 1

| | | | | | Positive electrode | | | | | Lithium-ion | |
|---|---|---|---|---|---|---|---|---|---|---|---|
| | Conductive layer | | | | | Film | Adhesion | Compacted | | battery | |
| | | | 2087.1 × | T/(2087.1 × | Contact | resistance | force | density | Porosity | IMP | ED |
| Embodiment | CW | T | CW − 76.8 | CW − 76.8) | angle θ (°) | (Ω) | (N/m) | (g/cm³) | (%) | (Ω) | (wh/L) |
| Embodiment 1-1 | 0.144 | 175 | 223 | 0.78 | 44.7 | 0.642 | 12.4 | 2.0 | 47.5 | 7.54 | 277.1 |
| Embodiment 1-2 | 0.186 | 251 | 310 | 0.81 | 40.2 | 0.732 | 12.7 | 2.0 | 46.8 | 7.52 | 276.4 |
| Embodiment 1-3 | 0.204 | 310 | 350 | 0.89 | 41.2 | 0.675 | 13.4 | 2.0 | 46.6 | 7.25 | 275.3 |
| Embodiment 1-4 | 0.229 | 432 | 402 | 1.07 | 39.5 | 0.687 | 16.3 | 2.2 | 41.2 | 7.34 | 275.8 |
| Embodiment 1-5 | 0.25 | 483 | 445 | 1.09 | 37.5 | 0.612 | 14.5 | 2.2 | 40.5 | 7.34 | 274.5 |
| Embodiment 1-6 | 0.292 | 543 | 532 | 1.02 | 37.8 | 0.632 | 14.8 | 2.2 | 39.0 | 7.31 | 274.5 |
| Embodiment 1-7 | 0.329 | 665 | 611 | 1.095 | 36.5 | 0.667 | 15.6 | 2.2 | 38.3 | 7.26 | 275.6 |
| Embodiment 1-8 | 0.417 | 888 | 794 | 1.12 | 35.4 | 0.743 | 15.6 | 2.2 | 37.7 | 7.21 | 274.8 |
| Embodiment 1-9 | 0.5 | 1050 | 968 | 1.08 | 33.7 | 0.755 | 16.4 | 2.4 | 29.5 | 7.28 | 273.5 |
| Embodiment 1-10 | 0.684 | 1222 | 1351 | 0.90 | 30.3 | 0.668 | 16.7 | 2.4 | 27.9 | 7.2 | 273.9 |
| Embodiment 1-11 | 0.751 | 1500 | 1490 | 1.01 | 26.5 | 0.639 | 16.6 | 2.5 | 26.3 | 7.19 | 274.1 |
| Embodiment 1-12 | 0.809 | 1643 | 1612 | 1.02 | 25.4 | 0.612 | 15.9 | 2.5 | 25.5 | 7.12 | 272.3 |
| Comparative | 0.4 | 975 | 758 | 1.25 | 43.8 | 0.752 | 14.2 | — | — | 7.26 | 273.9 |
| Embodiment 1-1 | | | | | | | | | | | |

As can be seen from the data of the embodiments and comparative embodiments in Table 1, when the relationship between the thickness of the conductive layer and the coating weight falls within the range of 0.7<T/(2087.1×CW−76.8)<1.2, the lithium-ion battery exhibits a relatively high energy density on condition that the internal resistance meets a specified requirement. When the value of T/(2087.1×CW−76.8) is lower than 0.7, in order to obtain a low thickness of the conductive layer, a high-precision plate roller is required in the coating stage, thereby increasing the preparation cost of the lithium-ion battery and reducing the cost-effectiveness. When the value of T/(2087.1×CW−76.8) is higher than 1.2, a conductive layer slurry of a high solid content is required in the coating process. However, the high solid content of the conductive layer slurry makes the particles of the conductive layer prone to agglomerate with each other, and it is more difficult to spread out the conductive layer, thereby causing an adverse effect onto the resistance and energy density of the lithium-ion battery.

Table 2 shows how the relationship between the thickness T (nm) of the conductive layer and the coating weight (mg/cm²) of the conductive layer per unit area of the current collector as well as the solid content of the conductive layer slurry affect the positive electrode plate and the performance of the lithium-ion battery containing the positive electrode plate.

In each embodiment, the weight-average molecular weight of the first additive is 650000, and the molecular weight distribution index of the first additive is 1.32; the weight-average molecular weight of the second additive is 450000, and the molecular weight distribution index of the second additive is 1.57; the specific surface area of the conductive agent is 65 m²/g; and D₅₀ of the secondary particles of the conductive layer is 0.195 μm, and D₉₀ thereof is 0.261 μm.

Based on the mass of the conductive layer, the mass percent of the first additive is 2.5%, the mass percent of the second additive is 47.5%, and the mass percent of the conductive agent is 50%.

TABLE 2

| | Conductive layer | | | | | Positive electrode | | | | | Lithium-ion | |
|---|---|---|---|---|---|---|---|---|---|---|---|---|
| | | | | | Solid | | Film | Adhesion | Compacted | | battery | |
| | | | 2087.1 × | T/(2087.1 × | content | Contact | resistance | force | density | Porosity | IMP | ED |
| Embodiment | CW | T | CW − 76.8 | CW − 76.8) | (%) | angle θ (°) | (Ω) | (N/m) | (g/cm³) | (%) | (Ω) | (wh/L) |
| Embodiment 2-1 | 0.128 | 169 | 190 | 0.89 | 3 | 43.2 | 0.633 | 16.4 | 2.2 | 42.7 | 7.25 | 272.9 |
| Embodiment 2-2 | 0.232 | 450 | 407 | 1.11 | 10 | 38.7 | 0.643 | 17.2 | 2.2 | 40.2 | 7.21 | 272.2 |
| Embodiment 2-3 | 0.534 | 1145 | 1038 | 1.10 | 20 | 34.1 | 0.677 | 17.1 | 2.2 | 36.5 | 7.28 | 271.4 |
| Embodiment 2-4 | 0.743 | 1544 | 1474 | 1.05 | 25 | 23.3 | 0.764 | 17.4 | 2.2 | 34.6 | 7.19 | 271.1 |

As can be seen from the data in Table 2, with the increase of the solid content of the conductive layer slurry, both the coating weight and the thickness of the conductive layer increase accordingly. A main reason is that in the case of the same plate roller, the volume of the plate roller groove for storing the slurry is constant. The higher the solid content, the higher the solid content of the slurry in the groove, and the higher the coating weight and thickness of the conductive layer applied onto the current collector. An unduly high solid content leads to a large thickness of the conductive layer, thereby reducing the energy density. An unduly low solid content may result in omission of coating of the conductive layer, thereby affecting the resistance and adhesion, and in turn, impairing the performance of the lithium-ion battery.

Table 3 shows how the relationship between the thickness T (nm) of the conductive layer and the coating weight (mg/cm²) of the conductive layer per unit area of the current collector as well as D₅₀ and D₉₀ of the secondary particles of the conductive layer affect the positive electrode plate and the performance of the lithium-ion battery containing the positive electrode plate.

In each embodiment and comparative embodiment, the solid content of the conductive layer slurry is 15%; the weight-average molecular weight of the first additive is 650000, and the molecular weight distribution index of the first additive is 1.32; the weight-average molecular weight of the second additive is 450000, and the molecular weight distribution index of the second additive is 1.57; and the specific surface area of the conductive agent is 65 m²/g.

Based on the mass of the conductive layer, the mass percent of the first additive is 2.5%, the mass percent of the second additive is 47.5%, and the mass percent of the conductive agent is 50%.

TABLE 3

| | | | | | | | Positive electrode | | | | | Lithium-ion | |
|---|---|---|---|---|---|---|---|---|---|---|---|---|---|
| | | | Conductive layer | | | | Contact | Film | Adhesion | Compacted | | battery | |
| | D₁₀ | D₉₀ | | | 2087.1 × | T/(2087.1 × | angle | resistance | force | density | Porosity | IMP | ED |
| Embodiment | (μm) | (μm) | CW | T | CW − 76.8 | CW − 76.8) | θ (°) | (Ω) | (N/m) | (g/cm³) | (%) | (Ω) | (wh/L) |
| Embodiment 3-1 | 0.1 | 0.21 | 0.154 | 252 | 245 | 1.03 | 40.1 | 0.658 | 11.7 | 2.2 | 42.1 | 7.48 | 277.4 |
| Embodiment 3-2 | 0.2 | 0.26 | 0.372 | 688 | 700 | 0.98 | 37.5 | 0.645 | 14.3 | 2.2 | 41.5 | 7.42 | 276.9 |
| Embodiment 3-3 | 0.3 | 0.45 | 0.565 | 1230 | 1102 | 1.12 | 34.9 | 0.643 | 15.9 | 2.2 | 37.5 | 7.32 | 275.7 |
| Embodiment 3-4 | 0.4 | 0.6 | 0.796 | 1637 | 1585 | 1.03 | 25.6 | 0.755 | 16.7 | 2.2 | 37.2 | 7.21 | 274.4 |
| Embodiment 3-5 | 0.18 | 0.3 | 0.21 | 419 | 361 | 1.16 | 39.5 | 0.623 | 12.3 | 2.2 | 41.2 | 7.39 | 276.5 |
| Embodiment 3-6 | 0.26 | 0.4 | 0.411 | 753 | 781 | 0.96 | 36.2 | 0.684 | 13.9 | 2.2 | 38.3 | 7.29 | 274.8 |
| Embodiment 3-7 | 0.34 | 0.5 | 0.612 | 1254 | 1201 | 1.04 | 32.8 | 0.674 | 16.4 | 2.2 | 37.8 | 7.18 | 273.1 |
| Embodiment 3-8 | 0.38 | 0.6 | 0.823 | 1738 | 1641 | 1.06 | 24.4 | 0.717 | 16.6 | 2.2 | 37.1 | 7.17 | 272.5 |

As can be seen from the data in Table 3, with the increase of the particle size of the secondary particles of the conductive layer, both the coating weight and the thickness of the conductive layer increase, and the internal resistance and energy density of the battery decrease. A main reason is that, with the increase of the particle size of the secondary particles, the number of conductive layer particles decreases on the basis of the same solid content, and the conductive layer is spread out unevenly.

Although illustrative embodiments have been demonstrated and described above, a person skilled in the art understands that the foregoing embodiments are never to be construed as a limitation on this application, and changes, replacements, and modifications may be made to the embodiments without departing from the spirit, principles, and scope of this application.

What is claimed is:

1. An electrochemical device, comprising an electrode plate, wherein the electrode plate comprises a current collector, a conductive layer, and an active material layer; and
the conductive layer is disposed between the current collector and the active material layer; and
the electrochemical device satisfies the following relation: 0.7<T/(2087.1×CW−76.8)<1.2, wherein
T (nm) is a thickness of the conductive layer, and CW (mg/cm²) is a coating weight of the conductive layer per unit area of the current collector.

2. The electrochemical device according to claim 1, wherein the electrochemical device satisfies at least one of the following conditions (a) to (c):
(a) 0.8<T/(2087.1×CW−76.8)<1.2;
(b) 100<T≤2000; or
(c) 0.1<CW≤1.

3. The electrochemical device according to claim 1, wherein the electrochemical device satisfies at least one of the following conditions (d) to (e):
(d) 200<T≤1500; or
(e) 0.3<CW≤0.8.

4. The electrochemical device according to claim 1, wherein a contact angle θ of the conductive layer with respect to N-methyl-pyrrolidone satisfies: 20°≤θ≤50°, and the contact angle θ is measured by a contact angle meter.

5. The electrochemical device according to claim 1, wherein the conductive layer comprises a secondary particle formed from a primary particle of a conductive agent, and D₅₀ and D₉₀ of the secondary particle satisfy: 0.1 μm≤D₅₀≤0.4 μm, and 0.2 μm≤D₉₀≤0.6 μm.

6. The electrochemical device according to claim 1, wherein the conductive layer comprises a first additive and a second additive; the first additive comprises at least one of a polyether polyol or a cellulose ether; and the second additive comprises at least one of a polycarboxylate salt, a polycarboxylate ester, or a polycarboxylic acid.

7. The electrochemical device according to claim 6, wherein the first additive and the second additive satisfy at least one of the following conditions (f) to (1):
(f) a weight-average molecular weight of the first additive is 400000 to 800000;
(g) a weight-average molecular weight of the second additive is 300000 to 600000;
(h) the first additive comprises the polyether polyol; the polyether polyol comprises at least one of a trihydroxy polyether, a phenol polyoxyethylene ether, a polyethylene glycol dimethyl ether, or a polyether-modified glycerol;
(i) the first additive comprises the cellulose ether; the cellulose ether comprises at least one of methyl cellulose, hydroxyethyl methyl cellulose, carboxymethyl cellulose, sodium carboxymethyl cellulose, ethyl cellulose, benzyl cellulose, hydroxyethyl cellulose, hydroxypropyl cellulose, cyanoethyl cellulose, benzyl cyanoethyl cellulose, carboxymethyl hydroxyethyl cellulose, or phenyl cellulose;
(j) the polycarboxylate salt comprises at least one of sodium polyacrylate or sodium polymethacrylate; the polycarboxylic acid comprises at least one of a polyacrylic acid or a polymethacrylic acid; and the polycarboxylate ester comprises at least one of polyvinyl acetate, poly(2-hydroxyethyl methacrylate), or poly(isobutyl methacrylate);
(k) based on a total mass of the conductive layer, a mass percent of the first additive is 1% to 5%, and a mass percent of the second additive is 20% to 55%; or
(l) a mass ratio between the first additive and the second additive is 1:4 to 1:50.

8. The electrochemical device according to claim 5, wherein the conductive agent satisfies at least one of the following conditions (m) to (o):
(m) the conductive agent comprises at least one of conductive carbon black, acetylene black, carbon fibers, carbon nanotubes, or Ketjen black;
(n) a specific surface area of the conductive agent is 50 m²/g to 100 m²/g; or
(o) based on a total mass of the conductive layer, a mass percent of the conductive agent is 40% to 75%.

9. The electrochemical device according to claim 1, wherein a solid content of a conductive layer slurry that forms the conductive layer is 3% to 25%.

10. The electrochemical device according to claim 1, wherein the electrode plate satisfies at least one of the following conditions (p) to (s):
(p) a film resistance of the electrode plate is 0.05Ω to 5Ω;
(q) an adhesion force between the conductive layer and the active material layer is 10 N/m to 100 N/m;
(r) a compaction density of the electrode plate is 2.0 g/cm³ to 2.5 g/cm³; or
(s) a porosity of the electrode plate is 20% to 50%.

11. The electrochemical device according to claim 1, wherein the electrode plate is a positive electrode plate.

12. An electronic device, comprising an electrochemical device, the electrochemical device comprises an electrode plate, wherein the electrode plate comprises a current collector, a conductive layer, and an active material layer; and the conductive layer is disposed between the current collector and the active material layer; and
the electrochemical device satisfies the following relation: 0.7<T/(2087.1×CW−76.8)<1.2, wherein
T (nm) is a thickness of the conductive layer, and CW (mg/cm²) is a coating weight of the conductive layer per unit area of the current collector.

13. The electronic device according to claim 12, wherein the electrochemical device satisfies at least one of the following conditions (a) to (c):
(a) 0.8<T/(2087.1×CW−76.8)<1.2;
(b) 100<T≤2000; or
(c) 0.1<CW≤1.

14. The electronic device according to claim 12, wherein the electrochemical device satisfies at least one of the following conditions (d) to (e):
(d) 200<T≤1500; or
(e) 0.3<CW≤0.8.

15. The electronic device according to claim 12, wherein a contact angle θ of the conductive layer with respect to N-methyl-pyrrolidone satisfies: 200°≤θ≤50°, and the contact angle θ is measured by a contact angle meter.

16. The electronic device according to claim 12, wherein the conductive layer comprises a secondary particle formed from a primary particle of a conductive agent, and D50 and D90 of the secondary particle satisfy: 0.1 μm≤D50≤0.4 μm, and 0.2 μm≤D90≤0.6 μm.

17. The electronic device according to claim 12, wherein the conductive layer comprises a first additive and a second additive; the first additive comprises at least one of a polyether polyol or a cellulose ether; and the second additive comprises at least one of a polycarboxylate salt, a polycarboxylate ester, or a polycarboxylic acid.

18. The electronic device according to claim 17, wherein the first additive and the second additive satisfy at least one of the following conditions (f) to (1):
(f) a weight-average molecular weight of the first additive is 400000 to 800000;
(g) a weight-average molecular weight of the second additive is 300000 to 600000;
(h) the first additive comprises the polyether polyol; the polyether polyol comprises at least one of a trihydroxy polyether, a phenol polyoxyethylene ether, a polyethylene glycol dimethyl ether, or a polyether-modified glycerol;
(i) the first additive comprises the cellulose ether; the cellulose ether comprises at least one of methyl cellulose, hydroxyethyl methyl cellulose, carboxymethyl cellulose, sodium carboxymethyl cellulose, ethyl cellulose, benzyl cellulose, hydroxyethyl cellulose, hydroxypropyl cellulose, cyanoethyl cellulose, benzyl cyanoethyl cellulose, carboxymethyl hydroxyethyl cellulose, or phenyl cellulose;
(j) the polycarboxylate salt comprises at least one of sodium polyacrylate or sodium polymethacrylate; the polycarboxylic acid comprises at least one of a polyacrylic acid or a polymethacrylic acid; and the polycarboxylate ester comprises at least one of polyvinyl acetate, poly(2-hydroxyethyl methacrylate), or poly(isobutyl methacrylate);
(k) based on a total mass of the conductive layer, a mass percent of the first additive is 1% to 5%, and a mass percent of the second additive is 20% to 55%; or
(l) a mass ratio between the first additive and the second additive is 1:4 to 1:50.

19. The electronic device according to claim 16, wherein the conductive agent satisfies at least one of the following conditions (m) to (o):
(m) the conductive agent comprises at least one of conductive carbon black, acetylene black, carbon fibers, carbon nanotubes, or Ketjen black;
(n) a specific surface area of the conductive agent is 50 m2/g to 100 m2/g; or
(o) based on a total mass of the conductive layer, a mass percent of the conductive agent is 40% to 75%.

20. The electronic device according to claim 12, wherein a solid content of a conductive layer slurry that forms the conductive layer is 3% to 25%.
